(19) United States
(12) Patent Application Publication
(10) Pub. No.: US 2009/0040558 A1
(43) Pub. Date: Feb. 12, 2009

(54) METHOD AND ARRANGEMENT FOR ARCHIVING DOCUMENT DATA AND FOR OUTPUTTING DOCUMENT DATA STORED IN AN ARCHIVE

(76) Inventor: Hartwig Schwier, Munchen (DE)

Correspondence Address: SCHIFF HARDIN, LLP;PATENT DEPARTMENT, 6600 SEARS TOWER, CHICAGO, IL, 60606-6473, US

(21) Appl. No.: 12/278,876

(22) PCT Filed: Feb. 6, 2007
(86) PCT No.: PCT/EP2007/051091

§ 371 Date: Aug. 8, 2008

(30) Foreign Application Priority Data
Feb. 9, 2006 (DE) 10 2006 006 060.1

(51) Int. Cl. G06F 3/12

(52) U.S. Cl. 358/1.15

(57) ABSTRACT

In a method or system for operating document data, an output job for outputting a document based on document data is generated by a data processing unit, the output job comprising at least one instruction indicating whether the document data of the output job is to be archived. The output job for generation of the at least one document with the document data is supplied to an output management system, the output management system receiving the document data from various application systems and implementing production planning and production control for multiple output systems by distributing various output jobs to available output systems. The document data in the output job to be archived based on the at least one archiving instruction is transferred from the output management system to an archiving system or to a document management system for archiving. Index information is associated with the document data to be archived at least in the archiving system or the document management system for archiving. The index information is automatically determined and associated with the document data to be archived such that at least one part of the index information is determined from a job ticket associated with the output job.

### BACKGROUND

The preferred embodiment concerns a method and an arrangement for archiving of document data in which a print job is generated for generation of a document. The preferred embodiment also concerns a method and an arrangement for output, with the aid of at least one printing system, of document data stored in an archive of an archiving system or of document data provided by a document management system (DMS), in which printing system the document data of a document to be printed and are stored in the archive of an archiving system are selected. The preferred embodiment also concerns a computer program product for execution of a method according to the invention with the aid of a data processing system, as well as a data medium for storage of the computer program product.

Printing systems are known in which print jobs that are generated for applications are supplied to an output management system that administers these print jobs and relays them to suitable printers to print the print job.

An output management system with the name “PRISMAsatellite” that controls the distribution of print jobs and thereby improves the efficiency of the print operation is described in Chapters 14 and 16 in the publication “Digital Printing, Technology and Printing Techniques of Océ Digital Printing Presses”, 9th Edition, February 2005, (ISBN 3-00-001081-5).

Such an output management system in print centers receives document data from various input systems and relays these to suitable printing devices. The output management system generally serves as an interface between at least one application program and at least one printing system and serves as an instance. The output management system implements the production planning and the production control for the printing systems and for this distributes various print jobs to available printing systems. Furthermore, the output management system can in particular implement a color management for different printing systems through [sic] and implement a monitoring of the available printing systems via detection of the status of the printing system and the monitoring of the print jobs. A resource monitoring and the generation of reports about the status and comparison of printing systems and consumable materials is also optionally possible with the aid of an output management system. Furthermore, a conversion or transformation of a print data stream can occur with the aid of an output management system.

The print jobs supplied to an output management system and/or the print jobs supplied by the output management system to the printing systems advantageously comprise what is known as a job ticket. A job ticket is a file that is generated by the user or by the application program upon creation of the print job and in which are contained instructions or data accompanying the print job which are to be executed in the printing process as well as advantageously in the pre-processing and/or post-processing of the recording materials to be printed. The instructions accompanying the print job as well as the data of the job ticket are advantageously stored in a file. This file is normally transferred together with the document data to the output management system. The output management system is the instance that also competently processes the at least one part of the information contained in the job ticket when the job ticket is incorrect (in particular when it is incomplete).

Conventional job tickets contain unambiguous instructions that are correspondingly converted by the printing system. Due to the integration of additional apparatuses and devices into the printing process, in particular for pre- and/or post-processing of the recording material to be printed, the printing process is becoming more comprehensive and the functional diversity increases. The job ticket associated with a print job advantageously comprises information about at least one pre-processing, a printing process and a print-post-processing. The job ticket can specifically possess information about: the insertion of register sheets; the cutting; the sorting and binding of the printed recording material; the color defaults; the quality to be generated; the generation and/or return of a preliminary; the generation of the complete document to be printed and/or to be archived with the aid of a page description language, including the required fonts not present in the output system; the color conversion to the present output colors of the output system; an enlargement/reduction factor; a page numbering of the document; a paper format; a paper quality; the number of pages to be printed on one sheet; and/or additional parameters.

Furthermore, due to the spread of the Internet and due to the development of various intranets, printing processes are increasingly executed with regional distribution or are associated with a pool of printers that can be regionally distributed. Moreover, apparatuses of different manufacturers are increasingly combined to generate a document or to produce a print product, which apparatuses must then cooperate in a production process, what is known as a workflow. In order to satisfy the requirements thereby present for the information contained in the print job or in the job ticket, a uniform specification is agreed upon for exchange of print job data in the printing process. Such a specification advantageously comprises what is known as a job definition format (JDF) that is an open file format based on the XML format.

The JDF enables the direct data exchange between different data processing units and control units in the printing process as well as in the pre- and post-processing. The JDF in particular specifies the job ticket that contains the job data of a print job. The JDF also comprises a format for message exchange (job messaging format—JMF) as well as a protocol for message exchange.

A control instance that transmits job data to the respective executing apparatus is advantageously provided in the printing system, whereby the executing apparatus transmits REAL values back to the control instance. The specification of the JDF is provided as a document on the Internet site www.cip4.org, whereby the current specification exists at Version 1.3. In JDF the instructions for a printing process are arranged in a tree structure with multiple nodes. Each node comprises an instruction or a set of instructions. The top-most node is designated as a root. The end nodes at the branches are designated as leaf nodes. Furthermore, the nodes are hierarchically subdivided, wherein in the tree structure product nodes are provided at the peak or in the upper region, process group nodes are provided in a middle region and process nodes are provided in a lower region.

A characteristic of the JDF is that what are known as intent nodes can be provided that contain very general instructions for a printing process that must be rendered more precisely at a later point in time in order to be able to be executed by an apparatus. The product nodes are in particular designated as product intent nodes. The more precise rendering of these instructions (that is also designated as resolution) is executed by a corresponding controller in the course of the printing process in that one or more additional nodes that render the instructions of the intent node more precisely are subordinated to the intent node. This resolution can occur in steps, meaning that a cascade of additional nodes are subordinated in steps to the intent node, wherein the exact instructions for the respective apparatus (in particular for the printer) are contained in the nodes of the lowermost hierarchy level (i.e. the leaf nodes).

The resolution of the intent instructions into more precise instructions, up to the commands contained in the leaf nodes, occurs with the aid of programs that are designed similar to device drivers and that convert the general intent instructions into concrete intent instructions or into concrete commands for a printer or an apparatus. Information about resources that are contained in the respective nodes are also taken into account in this conversion. According to the JDF specification, resources are all things that are consumed or produced. They in particular comprise physical objects such as, for example, paper, ink and data in the form of files or parameters. A resource has an XML ID with which it can be identified in the entire job ticket.

Document processing jobs can be automatically processed with the aid of a job ticket according to the JDF by a system that comprises networked computers, wherein the apparatuses that execute the document processing job are automatically determined. These apparatuses are in particular printers, folding devices, hole-punch devices, binding devices and the like. These apparatuses are automatically determined in that specific criteria are predetermined by the print job and an apparatus that corresponds to these criteria is selected. Such a method has already proven itself in conventional systems for automatic processing of document processing jobs.

Furthermore, archiving systems are known via which document data can be stored in an archive. The document data stored in the archive can be loaded from the archive again at a later point in time and processed further. Archiving systems are known in which images of printed documents are stored in the form of pixel data. The archiving of document data is relatively complicated since these document data must be supplied to the archiving system for archiving. The location of the document data belonging to a document is often quite difficult, even when an indexing of document data in the archiving system is present, via which indexing keywords that should meaningfully characterize the document data are associated with said document data.

A system in which print data are output in parallel for printing at an archiving system is known from the document U.S. Pat. No. 5,940,584. A printing system in which multiple documents are combined into one print job is known from the document EP 0 700 006 A1. A system for generation of reprints of an already printed document is known from the document US 2004/0012802. A printing system in which a print image to be generated is matched to the page size of a recording material is known from the document U.S. Pat. No. 5,768,000. What is known as a preflight system to determine errors in document data is known from the document U.S. Pat. No. 6,608,697 B1. Basic aspects of the data flow in the processing of print jobs and document data are known from the document IS & T's NIP 13, 1997, International Conference on Digital Printing Technologies, Dr. Michael Has et al., “Workflow and Dataflow around Computer to Press Production”. The indexing of a print data stream in which a first print data stream is converted into a second print data stream and the print data contained in the print data stream are indexed and subsequently sorted dependent on the indexing is known from the document WO 01/77807. A sorting of the print data according to addresses contained in the print data thereby occurs in particular.

The use of a job ticket to process print jobs is known from the document EP 0 704 791 B. The content of the cited publication and of the cited documents is herewith incorporated by reference into the present specification.

### SUMMARY

It is an object to specify methods and arrangements in which an efficient data transfer is simply and efficiently possible between a printing system and a system to administer and/or store document data.

In a method or system for operating document data, an output job for outputting a document based on document data is generated by a data processing unit, the output job comprising at least one instruction indicating whether the document data of the output job is to be archived. The output job for generation of the at least one document with the document data is supplied to an output management system, the output management system receiving the document data from various application systems and implementing production planning and production control for multiple output systems by distributing various output jobs to available output systems. The document data in the output job to be archived based on the at least one archiving instruction is transferred from the output management system to an archiving system or to a document management system for archiving. Index information is associated with the document data to be archived at least in the archiving system or the document management system for archiving. The index information is automatically determined and associated with the document data to be archived such that at least one part of the index information is determined from a job ticket associated with the output job.

For a better understanding of the present invention, in the following reference is made to the exemplary embodiments presented in the drawings, which exemplary embodiments are described using specific terminology. However, it is noted that the protective scope of the invention should thereby not be limited since such variations and further modifications to the shown devices and the methods, as well as such additional applications of the invention as they are shown therein, are viewed as typical present or future knowledge of a competent man skilled in the art. The Figures show exemplary embodiments of the invention.

### BRIEF DESCRIPTION OF THE DRAWINGS

FIG. 1 is a schematic representation of a system for printing of documents and for archiving of the print data generated for printing;

FIG. 2 is a schematic representation of a system for printout of document data stored in an archive as a document;

FIG. 3 shows a workflow plan for archiving of document data;

FIG. 4 is a workflow plan for printing and/or archiving of document data;

FIG. 5 is a workflow plan for indexing of document data to be archived; and

FIG. 6 is a workflow plan for outputting a document with the aid of document data stored in an archive.

### DESCRIPTION OF THE PREFERRED EMBODIMENTS

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

Via a method for archiving of document data it is achieved that, with the aid of a print job, it can simply be specified that the document data of the print job to be archived are transferred from the output management system to the archiving system. Further operator control actions to archive the document data are thereby not absolutely necessary. The data for indexing of the document data to be archived are advantageously automatically taken from the print job, the properties of the document data, the document data themselves or a job ticket, or are determined from these. The possibility also exists to request the or additional indexing information via an input request in a print dialog in the generation of the print job. A simple structure for archiving of document data that enables the archiving of the document data in a simple manner is in particular enabled via the functional linking of the output management system with the archiving system via a job ticket of the print job. The production workflow (what is known as the workflow) is thereby not interrupted. It is thereby not required that a user comes into contact with the printing process itself and, for example, must select a printer driver.

A second aspect of the preferred embodiment concerns an arrangement for archiving of document data that has a data processing unit that generates at least one print job for generation of a document. The print job contains information about the document data of the print job to be archived. The arrangement also comprises an output management system for execution or processing of document data to be output and an archiving system for archiving of at least document data. The arrangement also comprises a system to feed at least one part of the print job and at least the document data to be archived to the output management system, wherein the output management system transfers at least the document data that are determined by the print job as to be archived to the archiving system.

Via such an arrangement a simple archiving of document data is possible since in particular the selection of the document data to be archived and the automatic feed of the document data of the print job that are to be archived to the archiving system is possible in a very simple manner.

A third aspect of the preferred embodiment concerns a method for outputting stored document data with the aid of a printing system in which the stored document data of a document to be printed are selected. A print job is generated with the aid of the selected document data and/or with the aid of the additional data associated with the selected document data. The generated print job in particular comprises a job ticket and document data for generation of the document. The selection of the document data in particular occurs via the selection of a folder associated with the document to be printed. The document data are advantageously stored in an archive of an archiving system or are provided by a document management system.

Via such a method according to the preferred embodiment, the output of a stored document in the form of a printed document from a document management system or an archive system is enabled in a simple manner. In particular, it is thereby not required that a user must himself come into contact with the printing process and, for example, must select a printer driver for printing of the document. A normally time-consuming opening of a program for processing of individually stored document data from the document management system (DMS) or the archive system can also be omitted.

The workflow for printout of documents from a document management system (DMS) or archive system is thereby significantly simplified because the corresponding application program does not have to be opened after selecting a stored document, and the document data are directly or automatically relayed to the output management system for printing.

A fourth aspect of the preferred embodiment concerns an arrangement for output of stored document data with the aid of at least one output system that comprises a data processing unit via which stored document data of a document to be printed can be selected. The data processing system generates a print job with the aid of the selected document data and/or the additional data associated with the selected data.

The output (in particular of document data stored in an archive and/or of document data provided by a document management system) to an output system such as, for example, a document management system or a printing system is possible in a simple manner via this arrangement in that in particular a job ticket is generated with the aid of the archiving system or an archived job ticket is used to generate the output job. The output job can thereby in particular be supplied to an output management system that relays the output job to a suitable output system, for example to a printing system. Via this arrangement it is also not required that a user comes into contact with the printing process itself and, for example, must select a printer driver for printing of the document. An opening of a program to process individual stored document data is also not required here.

A fifth aspect of the preferred embodiment concerns a computer program product with instructions and commands in encoded form that prompt a data processing system to execute method steps of a method for archiving of document data and/or to execute a method to output document data stored in an archive with the aid of an output system. The method according to the preferred embodiment can be executed simply via this computer program product.

A sixth aspect of the preferred embodiment concerns a data medium with a memory region that contains a computer program product according to the seventh aspect of the invention. A simple distribution and installation of the computer product is possible via such a data medium.

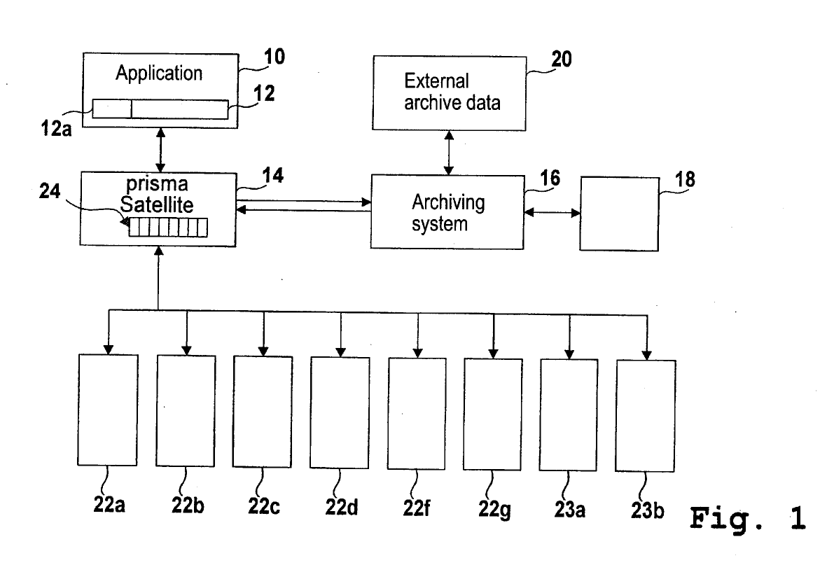

A schematic representation of a system for printing and archiving of document data generated in an application system 10 is shown in FIG. 1. The application system 10 outputs document data as an output job 12 that comprises a job ticket 12a according to the JDF standard. The output job 12 is supplied to an output management system 14, for example a “PRISMAsatellite” system from Océ Printing Systems. Depending on the output job 12 and on the information about the output job to be executed that is contained in the job ticket 12a, a printing system 22a through 22g, a system 23a for sending e-mail (such as, for example, an e-mail server) or a fax system 23b that satisfies at least the requirements for the document to be generated that are specified in the output job 12 or in the job ticket 12a is selected by the output management system 14 for execution of the output job 12. The output job 12 can thus be a print job, a job for sending at least one e-mail or a job for sending at least one telefax.

In general, output management systems 14 in printing centers accept document data from various input systems and, in the event that it is necessary, supplement these with additional elements and resources such as, for example, logos and signatures. An output management system 14 implements the production planning and the production control for the printing systems and for additional output management systems and for this distributes various output jobs to available output systems 22a through 22g, 23a, 23b. The output management system 14 also bundles individual output jobs or distributes one output job to multiple output systems. Furthermore, such an output management system 14 can control the load distribution (i.e. the economical utilization) of individual output systems. The output management system 14 in particular implements a color management for different printing systems 22a through 22g and a monitoring of the available output systems 22a through 22g, 23a, 23b by logging the status of each output system 22a through 22g, 23a, 23b and the monitoring of the output jobs. A resource monitoring and the creation of reports about the status and comparison of output systems 22a through 22g, 23a, 23b and consumable materials and/or costs is also possible with the aid of an output management system 14. In the event that it is necessary or desired, the output management system 14 can implement a translation or conversion of a print data stream.

If it is specified in the job ticket 12a or in the output job that the output data of the output job 12, the document data contained in the output job 12, or a portion of these output data or document data are to be supplied to an archiving system 16 or document management system for archiving, the output management system 14 determines these data to be archived and advantageously transfers these with the job ticket 12a to the archiving system 16 or, respectively, to the document management system. The output management system 14 can optionally convert the data to be archived into a special format adapted to the archiving system 16. The archiving system 16 advantageously automatically indexes the data to be archived with the aid of information that is present in the job ticket 12a or in the information contained in the output job 12. This information in particular comprises job ticket data such as date, sender and type of data/document category; organizational data such as, for example, ISBN, process number, department of the sender, time of the transfer per e-mail, page count and all data contained in the job ticket, advantageously in a job definition format. Index information is generated from these existing and/or additionally input information, which index information advantageously comprises: user information; parameters for specification of the category and/or a classification of the document; specifications regarding the print preparation, the printing process, the print post-processing, the point in time of the generation, the point in time of the printing, the enveloping point in time and/or the sending point in time; the document type, the version of the document; the document history; the processing history; the page count; the attachments of the document; the resource data required for generation of the document; the title; the document text; and/or information contained in the document text.

The archiving system 16 archives all document data associated with a document in a common folder that then advantageously contains all data for generation of a document. The job ticket 12a is advantageously also stored as a file in this folder.

Alternatively or additionally, special resources that are required for generation of the document are stored as well in this folder or in a separate resource folder. These resources in particular pertain to logos and fonts.

The document data to be archived are stored by the archiving system 16 in a memory 18 connected with the archiving system 16. Additional data to be archived can be supplied to the archiving system 16 from additional sources. These sources can in particular be scanners or data media with external archive data 20. A document management system can also advantageously be used as an archiving system 16.

The job ticket 12a can contain the information that the document data contained in the output job are only to be archived with the aid of the archiving system 16, should only be output with the aid of the output management system 14 on a printing system 22a through 22g or an additional output system 23a, 23b, or should both be archived with the aid of the archiving system 16 and be output with the aid of one of the output systems 22a through 22g, 23a, 23b. An output queue in the manner of a print queue is provided in the output management system 14 for each of the output systems 22a though 22g, 23a, 23b. The output queues have the general reference number 24.

In principle, output jobs with output data of a preset category can also always be archived without additional presets, independent of the specifications in the job ticket 12a. For example, such a category can be the category “account statements”. Such categories that must be archived, in particular due to legal regulations or internal company requirements, are advantageously preset. For example, the document data comprise an output data stream, in particular a print data stream such as, for example, an AFP print data stream or an IPDS data stream, documents and/or objects that have been generated by an application program, or documents in a page description language. A plurality of these document data can be combined with one another to generate a document with the aid of a printing system 22a through 22g, to send a document with the aid of an output system 23a, 23b, and/or to archive the document with the aid of the archiving system 16. In particular, a series print file generated with the aid of a word processing program (such as MS Word, for example) can be generated with a diagram graphic generated with an analysis application program, an image inserted as an external resource into the series print file and a PDF file (for example with a price list and general terms and conditions) in a document with a continuous page numbering. Given an output of the document with the aid of a printing system 22a through 22g, the printing system 22a through 22g advantageously also controls the pre- and post-processing of the document so that a bound brochure can be generated with a preset binding. The components for pre- and/or post-processing are thereby contained in the printing system 22a through 22g or are connected with the printing system 22a through 22g via at least one data line.

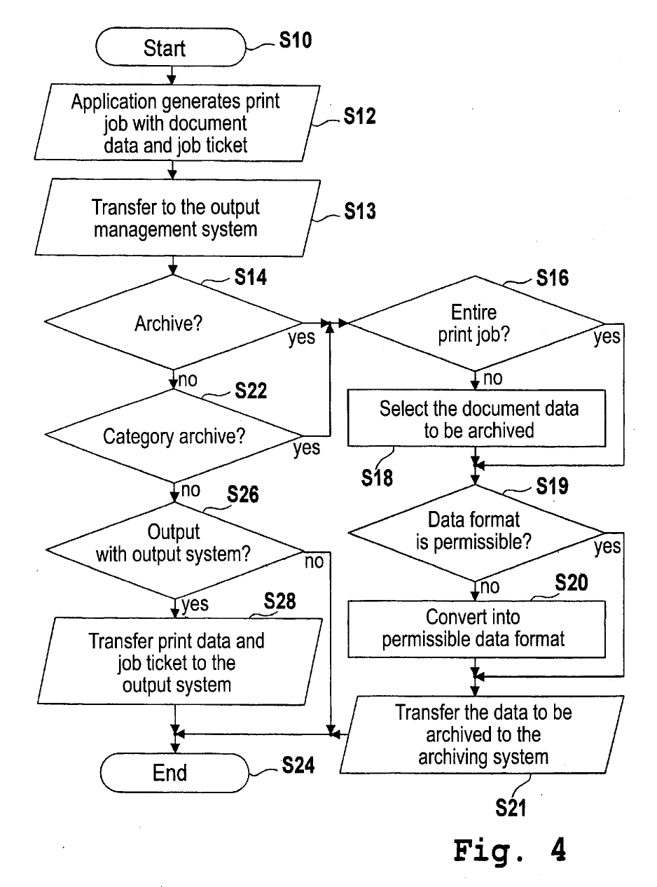

The resources merged into a document are respectively stored as a separate file, wherein the document data are transferred in the form of these files from the application 10 to the output management system 14 with the aid of the print job 12. Depending on the presets of the job ticket 12a, these files are then transferred from the output management system 14 to the archiving system 16 together with the job ticket 12a and/or to a suitable output system 22a through 22g, 23a, 23b. The archiving system 16, the output management system 14 and/or an interface program connected between the archiving system 16 and the output management system 14 analyzes the supplied databank interrogation command data and the job ticket associated with these document data and generates from this index information for indexing the document data in the archiving system 16. With the aid of this indexing information, the archived document and thus the archived document data can simply be searched for at a later point in time in that at least one part of the registered indexing information is used as a search term in the archiving system 16. The indexing is subsequently explained in detail in connection with FIG. 4.

As already mentioned, a document management system can advantageously also be introduced as an archiving system 16 in the sense of the preferred embodiment. Output data to be archived (such as, for example, print data, fax data, e-mail data as well as additional document data) are transferred from the output management system 14 to the archiving system 16 for archiving, in particular together with the job chaperone data (for example in the form of the job ticket). The output management system 14, the archiving system 16 or an interface program arranged between these systems extracts information from the job chaperone data of the job ticket, which information the archiving system 16 uses to index the output data to be archived. To output the archived document data (i.e. the archive data), the document data of an archived document are transferred from the archiving system 16 to the output management system 14, in particular together with additional documents connected with this document. The job chaperone data of the document or documents to be output are transferred to the output management system 14 together with the associated document data, which job chaperone data were advantageously contained in a job ticket associated with these documents before the archiving or are contained in the job ticket in the archiving of the job ticket data, and which are associated in the archiving system 16 with the document data to be transferred. A stored job ticket to output the document data can thereby be transferred unchanged from the archiving system 16 to the output management system 14 or alternatively can be adapted as needed. Alternatively, the possibility also exists to generate a new job ticket with the aid of the job chaperone data stored in the archiving system 16 and/or additional job chaperone data and to transfer the new job ticket from the archiving system 16 to the output management system 14. The job ticket can furthermore also be generated and/or adapted in an intervening instance between the archiving system 16 and the output management system 14. For example, such an instance can be an interface program. It is also possible to generate and/or to adapt the job chaperone data and/or the job ticket in the output management system 14 in the event that no job chaperone data and/or no job ticket are stored in the archiving system 14. Incoming job ticket data can thereby also be updated, altered and/or supplemented with additional job chaperone data in the document output management system 14.

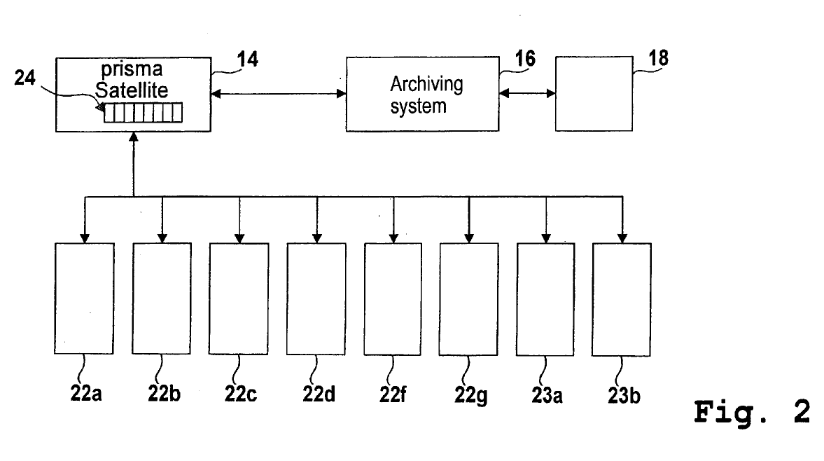

A schematic representation for output of a document archived in the archiving system 16 with the aid of archived document data, which output occurs with the aid of an output system 22a through 22g, 23a, 23b, is shown in FIG. 2, which is designed similar to the system according to FIG. 1. Identical elements have the same reference characters.

Via selection of a folder in the archiving system 16, a document is selected that should be output with the aid of a suitable output system 22a through 22g, 23a, 23b. In particular, the folder can be determined and selected with the aid of suitable search terms via a search for existing indexes of the archived document data. The archiving system 16 transfers the document data present in the selected folder as well as the job ticket 12a stored in the folder to the output management system 14, which selects a suitable output system 22a through 22g, 23a, 23b dependent on the document data and the specifications in the job ticket 12a and supplies the document data as output data to the output queue 24 associated with the output system 22a through 22g, 23a, 23b. The archiving system 16 can convert at least one part of the document data stored in a first data format in the selected folder into a second, suitable data format. This is in particular reasonable when the output management system 14 and/or the output system 22a through 22g, 23a, 23b selected by the output management system 14 does not support (i.e. cannot process) the first data format.

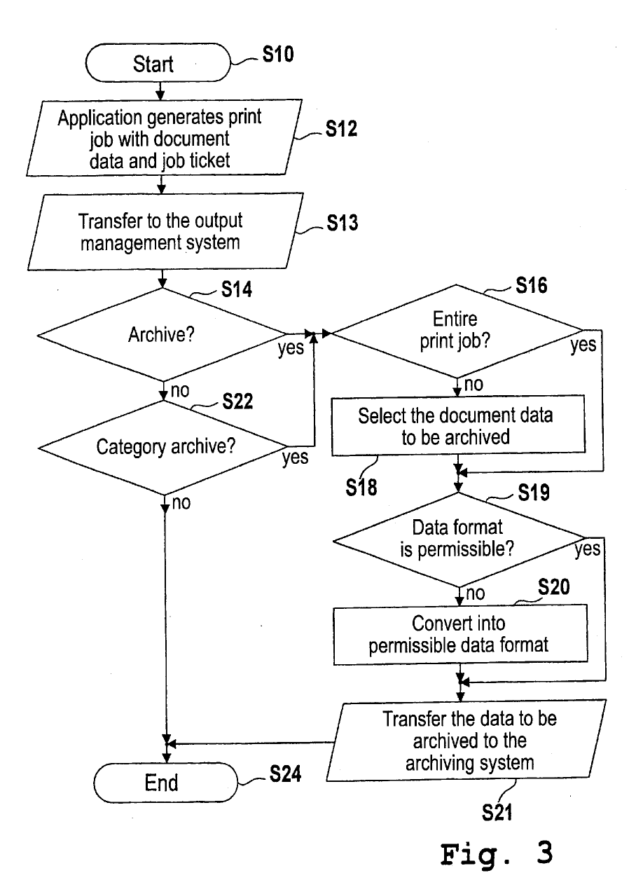

A workflow plan for archiving document data according to a first embodiment of the invention is shown in FIG. 3. The workflow is started in Step S10. An output job 12 which comprises document data and a job ticket 12a is generated in Step S12 by the application 20. Alternatively, the job ticket 12a can also be generated by an additional process for generation of the output job 12, which process is downstream of the application. The document data and the job ticket 12a of the output job 12 are transferred to the output management system 14 in Step S13. In Step S14, the output management system 14 subsequently checks whether information that indicates that at least one part of the document data contained in the output job 12 is to be archived is contained in the job ticket 12a. If that is the case, the output management system 14 subsequently checks in Step S16 whether the entire output job 12 is to be archived. If only a part of the document data of the output job 12 should be archived, in Step S18 the output management system 14 subsequently selects the document data of the output job 12 that are to be archived and subsequently checks in Step S19 whether the document data and/or the job ticket data possess an permissible data format. If that is not the case, in Step S20 at least the data that do not possess an permissible data format are subsequently converted into a permissible data format insofar as this is approved by a system controller and/or a job ticket setting. Subsequently, or if it is established in Step S19 that the data possess a permissible data format, the data to be archived are transferred from the organic semiconductor material 14 to the archiving system 16 in Step S21. The workflow is subsequently ended in Step S24. The archiving system 16 archives the document data to be archived and advantageously stores this together with the job ticket 12a for archiving in memory 18.

If the output management system 14 determines in Step S16 that all document data of the output job 12 are to be archived, in Step 20 the output management system 14 subsequently transfers all document data and the job ticket 12a of the output job 12 to the archiving system 16 that then archives these data in a suitable manner.

If the output management system 14 determines in Step S14 that the job ticket 12a contains no information that indicates that at least one part of the of the document data contained in the output job are to be archived, the output management system 14 subsequently checks in Step S22 whether the document data of the print job 12 are associated with a category for which it is preset that all document data of print jobs 12 of this category are to be archived. If that is the case, the workflow is continued in Step S16 as already described further above.

If the output management system 14 determines in Step S22 that the document data of the print job 12 are not associated with any category for which it is preset that the document data associated with this category are to be archived, the workflow is ended in Step S24.

A workflow plan for archiving of document data according to a second embodiment of the invention is shown in FIG. 4. Steps S10 through S24 coincide with the respective workflow steps of the workflow plan shown in FIG. 3 according to the first embodiment of the invention and are labeled with the same reference characters. After it has been established in Step S22 that no data of the output job are to be archived, or alternatively after the data to be archived have been transferred to the archiving system 16 in Step S21, the output management system 14 checks in Step S26 whether the document data contained in the output job should be output with the aid of an output system 22a through 22g, 23a, 23b. The information of whether these data is [sic] to be output with the aid of one of the output systems 22a through 22g, 23a, 23b is advantageously contained in the job chaperone data in the job ticket 12a.

If, in Step S26, the output management system 14 establishes that no output should occur with the aid of one of the output systems 22a through 22g, 23a, 23b, the workflow is ended in Step S24. However, if it established in Step S26 that an output should occur with the aid of an output system 22a through 22g, 23a, 23b, the output management system 14 selects a suitable output system 22a through 22g, 23a, 23b and, in Step S28, transfers only the document data or the document data together with the job ticket 12a to the selected output system 22a through 22g, 23a, 23b depending on the output system 22a through 22g, 23a, 23b.

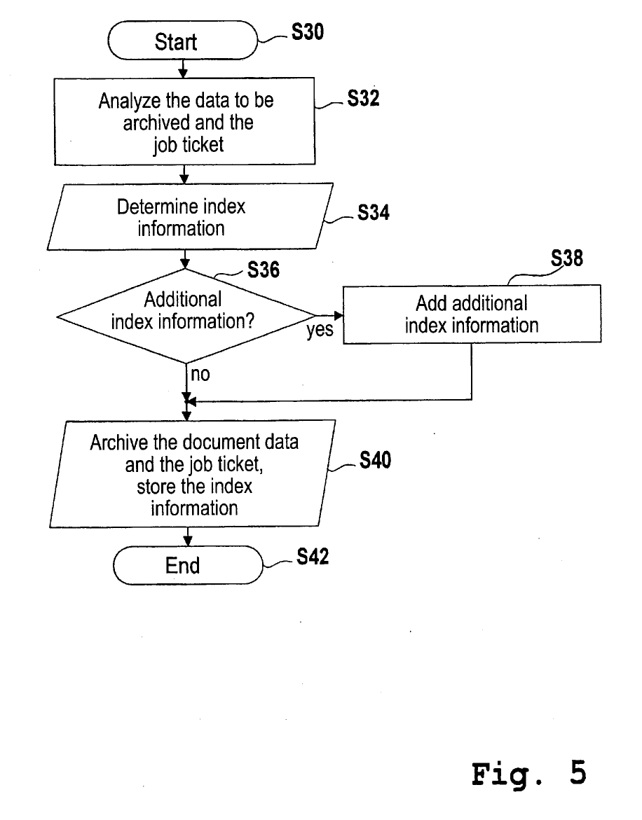

A workflow plan for indexing the document data to be archived in the archiving system 16 is presented in FIG. 5, which workflow plan is started at Step S30. The data to be archived can additionally be analyzed. Index information is subsequently determined in Step S34 from the job ticket data 12a and possibly additionally from the data to be archived. The index information can also be contained in encoded form in the data or the job ticket 12a. In Step S36 it is then determined whether additional index information is present or are to be added via operator inputs. If that is the case, in Step S38 index information is added, in particular via a user input or the readout of the additional index information from an additional data source such as a database. Subsequently, or if it is established in Step S36 that no additional index information is to be added, in Step S40 the index information associated with the document data is archived by the archiving system and stored in memory 18. The workflow is subsequently ended in Step S42. The storage of the data to be archived can also occur in a database, wherein a data set is then advantageously associated with a document.

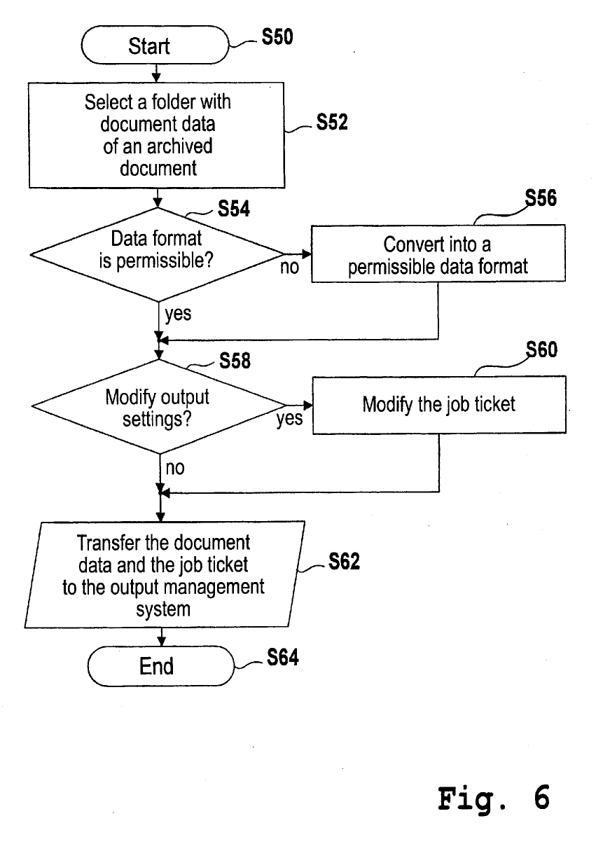

A workflow plan to output archived document data of an archived document or multiple documents to be output together is shown in FIG. 6, which workflow plan is started at Step S50. The documents to be output are subsequently selected in Step S52, in particular via the selection of at least one folder in which are stored document data of an archived document to be printed out. The selected document data are transferred from the archiving system 16 to the output management system 14. The output management system 14 selects a suitable output system 22a through 22g, 23a, 23b to output the document data to be output and subsequently checks in Step S54 whether the data format or data formats of the document data and advantageously of the job ticket 12a have a data format that is permissible, i.e. have a data format that can be processed further by an output system 22a through 22g, 23a, 23b connected with the output management 14.

If, in Step S54, the output management system 14 establishes that at least one part of the document data does not have a permissible format, in Step S56 the data format of at least these document data is subsequently converted into a permissible data format. Subsequently, or if it is established in Step S54 that the data formats of the document data and/or of the job ticket 12a are permissible, in Step S58 it is subsequently checked whether print settings to output the archived document are to be modified. If that is the case, in Step S60 the job ticket 12a is subsequently correspondingly changed. Subsequently, or if it is established in Step S58 that no print settings are to be changed, in Step S62 the document data and the job ticket 12a are associated with the print queue of an output system 22a through 22g, 23a, 23b or are transferred directly to the output system 22a through 22g, 23a, 23b, which has been selected by the output management system 14 dependent on the requirements for the output and further processing of the document. The requirements for the output system 22a through 22g, 23a, 23b for the output and possibly the further processing/pre-processing of printed/to-be-printed recording material are contained in the document data and/or in the job ticket 12a. The workflow is subsequently ended in Step S64.

As an alternative to the described archiving of the document data with the aid of the job ticket 12a, the archiving information and/or the category association of the document data can also be contained in an output job 12 without a job ticket 12a. In the event that the output management system 14 receives such an output job without job ticket 12a, the output management system 14 can generate a job ticket 12a. Even given document data to be archived without job ticket 12a, the output management system 14 can generate a job ticket 12a that can then be used to determine the indexing information. Given use of a job ticket 12a, this advantageously has a standardized job definition format (JDF) that has already been explained in detail in the specification preamble. The explanations of the job ticket and the JDF in the specification preamble as well as the additional descriptions in the specification preamble are also components of this specification. Such job tickets are also known from, among other things, the documents EP 0 704 791, U.S. Pat. No. 6,173,295 and U.S. Pat. No. 5,718,520. The explanations contained in these documents with regard to the job ticket as well as the remaining content of these documents is hereby incorporated by reference into the present specification.

In other embodiments, the document data is already provided by the application 10 in a page description language such as the PDF format. Alternatively, the document data supplied by the application 10 to the output management system 14 can be converted by the output management system 14 into document data of a page description language, wherein these converted document data are then supplied both to the output system 22a through 22g, 23a, 23b selected by the output management system 14 and in the archiving system 16 for archiving. Alternatively, the archiving system 16 can also convert archived document data that are not present in a preset page description language into this preset page description language before the transfer of these document data to the output management system 14, advantageously before archiving of these document data. Alternatively or additionally, the output management system 14 can convert the document data supplied by the archiving system 16 into a preset page description language and/or into a preset print data format.

The job ticket 12a defines an output job for generation and/or for archiving of a document as well as, advantageously, at least a portion of the pre- and/or post-processing of the recording material to be printed upon generation of the document in the output of the document with the aid of a printing system. The document data generated by the application 10 and to be archived by the archiving system 16 can comprise multiple resource files. These resource files and/or additional data of the output job 12 generated by the application 10 (which additional data are associated with the document data to be archived) are stored by the archiving system 16 in a folder created for this output job 12 or in a database entry of a database, which entry is associated with this output job 12. The job ticket 12a generated by the application 10 or alternatively generated by the output management system 14 is also advantageously stored by the archiving system 16 in at least one file in this folder or in the database entry.

The index information associated with the document data by the archiving system 16 are determined from the print data stream, the output job 12, the job ticket 12a and/or additional data. Index information is generated from this present and/or additionally input information, which index information advantageously comprises: user information; parameters for specification of the category and/or a classification of the document; specifications regarding the print preparation, the printing process, the print post-processing, the point in time of the generation, the point in time of the printing, the enveloping point in time and/or the sending point in time; the document type, the version of the document; the document history; the processing history; the page count; the attachments of the document; the resource data required for generation of the document; the title; the document text; and/or information contained in the document text.

The job ticket 12a associated with an output job 12 advantageously comprises information about at least one pre-processing, a printing process and/or a print post-processing. The job ticket 12a can especially possess information about: the insertion of register sheets; the cutting; the sorting and binding of the printed recording material; the color defaults; the quality to be generated; the generation and/or return of a preliminary; the generation of the complete document to be printed and/or to be archived with the aid of a page description language, including the required fonts not present in the output system; the color conversion to the present output colors of the output system 22a through 22g, 23a, 23b an enlargement/reduction factor; a page numbering of the document; a paper format; a paper quality; the number of pages to be printed on one sheet; and/or additional parameters.

A common job ticket 12a for archiving and output of a document is advantageously generated. The job ticket 12a comprises job chaperone data to define output jobs and/or archiving jobs. The document data and/or output job 12 to be archived comprise: a print data stream, in particular an AFP, Postscript, PCL, LCDS, PDF or IPDS print data stream; document data according to the page description language; and/or pixel data of a print image. The document data and the additional data to be archived are archived independent of the output properties of a possible output system 22a through 22g, 23a, 23b, in particular independent of the printer driver of a printing system 22a through 22g. After the archiving of the data transferred from the output management system 14 to the archiving system 16, the archiving system 16 transfers at least one item of notification information to the output management system 14 about the receipt and/or the archiving of these data.

The indexing of the document data to be archived by the archiving system 16 advantageously occurs automatically on the basis of the data supplied (in particular from the output management system 14) to the archiving system 16. One possibility of such an automatic indexing is known from the document WO 01/77807 A2, the content of which is incorporated by reference into the present specification.

Alternatively, or in addition to the information contained in the job ticket 12a, the archiving system 16 in particular determines the index information present in a supplied print data stream, for example the indexing elements for an AFP print data stream that are described in the document WO 01/77807 A1.

A document management system can also advantageously be used in the archiving system in the sense of the preferred embodiment. A document management system in particular serves to provide document data for various processes, advantageously to move the document data between the processes, and is thus an interface between the various processes (advantageously between various application programs). The document management system supports at least the workflow of these processes or application programs in that it administers, provides and/or stores the required document data. The document management system can also control the workflow between various processes and/or various application programs and serves for interactive processing of documents and/or document data. Such document management systems are also designated as workflow systems and, for example, pertain to workflows of the areas of accounting, EDV, allocations, payments etc. as well as combined workflows between the areas. Such document management systems are available under the trade names “Hummingbird Enterprise” from Hummingbird Ltd., Toronto, Ontario (Canada) as well as “Leonardo” from Siav S.p.A., Rubàno, Padova (Italy), for example.

A print job that, for example, is generated by an application program advantageously serves as an output, whereby a printing system is advantageously used as an output system.

The preferred embodiment is suitable to be realized as a computer program (software). It can therefore be distributed as a computer program product or computer program module, in particular in the form of a file on a data medium such as a diskette or CD-ROM or as a file via a data or communication network. Such and comparable computer program products and computer program elements are embodiments of the invention. The workflow according to the preferred embodiments can be applied in a data processing unit (computer), in a printing apparatus, in a printing system with upstream or downstream data processing apparatuses or in an additional output apparatus 23a, 23b, and can in particular be integrated into additional workflows. The data processing units and apparatuses can thereby be executed as separate data processing units and data processing apparatuses or be integrated into the printing apparatus or into a printing system. The data processing units and data processing apparatuses on which the invention is applied with the aid of a program can contain additional known technical devices such as input means (keyboard, mouse, touchscreen), a microprocessor, a data and/or control bus, a display device (monitor, display) as well as a working memory and a fixed disk storage as well as a network card.

Although preferred exemplary embodiments have been shown and described in detail in the drawings and in the preceding specification, they should be viewed as merely examples and not as limiting the invention. It is noted that only the preferred exemplary embodiments are presented and described, and all variations and modifications that presently and in the future lie within the protective scope of the invention should be protected.

1-37. (canceled)

38. A method for outputting document data, comprising the steps of:
generating an output job by a data processing unit for outputting a document based on document data, the output job comprising at least one archiving instruction indicating whether the data of the output job is to be archived;
supplying the output job for the generation of the at least one document with the document data to an output management system, the output management system receiving the document data from various application systems and implementing production planning and production control for multiple output systems by distributing various output jobs to available output systems;
transferring the document data in the output job to be archived based on the at least one archiving instruction from the output management system to an archiving system or to a document management system for archiving;
associating index information with the document data to be archived at least in the archiving system or the document management system for archiving; and
automatically determining and associating the index information with the document data to be archived such that at least one part of the index information is determined from a job ticket associated with the output job.

39. A method according to claim 38 wherein:
the output job has the job ticket for generation of the document, wherein the job ticket contains the instruction to archive the document data to be archived;
at least data of the job ticket and at least the document data to be archived are transferred to the output management system; and
the document data to be archived that are established by the archiving instruction and which is contained in the job ticket are transferred from the output management system to the archiving system.

40. A method according to claim 38 wherein:
the output job comprises at least document data for generation of the document to be output and the job ticket;
an output system for output of the document is selected by the output management system; and
the output system is prompted by the output management system to output the document.

41. A method according to claim 38 wherein at least one of a printed document, an e-mail document, a fax document, and an electronic document can be generated or is generated, wherein the output job comprises a print job with which the respective document can be generated.

42. A method according to claim 39 wherein the job ticket defines the output job for generation of the document with the aid of a printing system, and wherein the job ticket defines at least one part of at least one of pre- and post-processing of a recording material to be printed in the generation of the document.

43. A method according to claim 38 wherein the document data to be archived comprise multiple resource files, wherein at least one of the resource files and addition data of the output job that are to be associated with the document data to be archived are stored by the archiving system in a folder created for said output job or a database entry of a database that is associated with said output job, and wherein the job ticket is also stored as additional data associated with the document data to be archived in at least one file in said folder or in the database entry of the archiving system.

44. A method according to claim 38 wherein at least one part of the index information is determined from at least one of a print data stream and the output job.

45. A method according to claim 44 wherein at least one part of the index information is determined from additional data.

46. A method according to claim 44 wherein the index information comprises at least one of: user information; parameters for specification of a category and a classification of the document; specifications regarding at least one of print preparation, a printing process, a print post-processing, a point in time of the generation, a point in time of the printing, an enveloping point in time, and a sending point in time; a document type; a version of the document; a document history; a processing history; a page count; attachments of the document; resource data required for generation of the document; a title; a document text; and information contained in the document text.

47. A method according to claim 38 wherein the output job has information about at least one of a pre-processing, a printing process and a print post-processing, and specifically information about: insertion of register sheets; cutting; sorting and binding of a printed recording material; color defaults; quality to be generated; at least one of generation and return of a preliminary; at least one of generation of the complete document to be output and to be archived with aid of a page description language, including required fonts not present in the output system; color conversion to present output colors of the output apparatus; an enlargement/reduction factor; a page numbering of the document; a paper format; a paper quality; number of pages to be printed on one sheet; and additional parameters that are contained in the job ticket.

48. A method according to claim 38 wherein the output data of the output job are associated with a wait queue with aid of the output management system, wherein multiple print queues for different output systems are provided that are administered by the output management system.

49. A method according to claim 48 wherein an output system is associated with each wait queue.

50. A method according to claim 39 wherein the job ticket has job chaperone data to at least one of define output jobs and archival jobs, and wherein a common job ticket for archiving and output of a document is generated as the job ticket.

51. A method according to claim 39 wherein the job ticket is generated in a job definition format based on an XML standard.

52. A method according to claim 38 wherein at least the document data of a first data format are converted into a second format before or upon archiving, said data format being a page description language.

53. A method according to claim 52 wherein at least one part of the document data for generation of the document to be printed or archived is converted into a page.

54. A method according to claim 38 wherein the archived document data comprise: a print data stream.

55. A method according to claim 38 wherein at least one part of the document data is automatically transferred to the archiving system and archived based on the information contained in the job ticket.

56. A method according to claim 38 wherein the document data or the additional data to be archived are archived independent of output properties of the output system.

57. A method according to claim 38 wherein after the archiving of data transferred from the output management system for archiving, the archiving system transmits at least one item of notification information to the output management system about a receipt or the archiving of said data.

58. A method according to claim 38 wherein the output job comprises a print job, and the output data are print data output with aid of a printing system, a fax sending system, or an e-mail sending system.

59. A system for archiving of document data, comprising:
a data processing unit that generates at least one output job for generation of a document, the output job comprising at least one instruction for archiving of document data;
an output management system to administer document data to be output, the output management system accepting document data from application systems and implementing production planning and production control for multiple output systems by distributing output jobs to available output systems;
an archiving system for archiving of at least document data;
a supply system which supplies at least a portion of the output job and at least the corresponding document to be archived from the data processing unit to the output management system; and
the output management system transferring the document data to be archived to the archiving system and automatically determining and associating index information with respect to the document data to be archived, and determining at least one part of the index information from a job ticket associated with the output job.

60. A computer-readable medium comprising a computer program for outputting document data, said program performing the steps of:
generating an output job by a data processing unit for outputting a document based on document data, the output job comprising at least one archiving instruction indicating whether the data of the output job is to be archived;
supplying the output job for the generation of the at least one document with the document data to an output management system, the output management system receiving the document data from various application systems and implementing production planning and production control for multiple output systems by distributing various output jobs to available output systems;
transferring the document data in the output job to be archived based on the at least one archiving instruction from the output management system to an archiving system or to a document management system for archiving;
associating index information with the document data to be archived at least in the archiving system or the document management system for archiving; and
automatically determining and associating the index information with the document data to be archived such that at least one part of the index information is determined from a job ticket associated with the output job.
